(19) United States
(12) Patent Application Publication
(10) Pub. No.: US 2008/0282900 A1
(43) Pub. Date: Nov. 20, 2008

(54) Ingenious Lid Structure for Infusion Drinks Percolator

(76) Inventor: Po-Chun Huang, Taipei City (TW)

Correspondence Address: HDSL, 4331 STEVENS BATTLE LANE, FAIRFAX, VA, 22033, US

(21) Appl. No.: 12/120,299

(22) Filed: May 14, 2008

(30) Foreign Application Priority Data
May 17, 2007 (TW) 096207951

(51) Int. Cl. A47J 31/44

(52) U.S. Cl. 99/322; 99/323; 220/212

(57) ABSTRACT

A lid structure includes a lower lid slightly flared at the upper fringe, and having an engagement flange formed around it with a claw provided on its upper edge. A cutting tube of an upper lid is extended down from the center of the upper lid and inserted into the lower lid. The bottom of the cutting tube is also tilted. A detent is formed on the inner surface at the lower end of the upper lid to engage with the claw of the engagement flange so as to couple tightly the two lids. Several gaskets are provided around the inner side wall of the upper lid. An infusion drink material is filled into the cutting tube of the upper lid, and a film is used to seal the bottom of the lower lid.

### BACKGROUND OF THE INVENTION

1. Field of the Invention

The present invention relates to an ingenious lid structure for infusion drinks percolator in which any kinds of infusion drink material can be filled into the percolator container from the lid, and the lid is compatible to be engaged with the percolator container of universal structure so as to maintain perfect sanitary condition and reliable security.

2. Description of the Prior Art

There are many ready made bottle filled drinks on the market, for example, Woolung tea drink, Ginseng drink or the like instant drinks. However, it is a pity impossible to enjoy cold infusion tea or Ginseng drink outdoor when on an excursion. The ready made drinks are usually in lack of freshness and preservability and not as tasty as the instantly made drinks prepared by the consumer himself/herself at the site.

The ready made drinks on the market have aforesaid inherent shortcomings which have to be rectified for the public.

Aiming at the above depicted defects of the ready made drinks, the present invention is to propose an ingenious lid structure for infusion drinks percolator which is the fruit of the inventor's long time research based on many years of experience gained through professional engagement with the related products. The invention will certainly provide an opportunity for the user to prepare his/her own infusion drinks to enjoy anytime and anywhere.

### SUMMARY OF THE INVENTION

It is an object of the present invention to provide an ingenious lid structure for infusion drinks percolator in which the lid is compatible to be engaged with a universally structured container, and any kinds of infusion drink material can be filled into the container from the lid.

It is another object of the present invention that the aforesaid lid structure is simply constructed, easily operative without any extra manual work.

To achieve the aforesaid objects, gist of the present invention is directed to provide a lower lid, an upper lid, and a film. The lower lid is provided with an engagement flange around it so as to engage with the port of an ordinary universal liquid container. At a proper position on the lower lid above the engagement flange there is formed a claw, and the bottom of the lower lid is formed into a tilted port. A cutting tube provided in the middle of the upper lid is inserted into the lower lid and the bottom of the cutting tube is also formed into a tilted port. A detent is formed on the inner side surface at the lower end of the upper lid to engage with the claw of the lower lid so as to couple the upper lid and the lower lid together in one piece. More than one gaskets are provided around the inner side wall of the upper lid. With this structure, the infusion, drink materials such as tea leaves, Ginseng powders are filled into the cutting tube of the upper lid and sealing the tilted port of the lower lid so as to keep the infusion drink materials contained between the upper lid and the lower lid in a hermetic state thereby maintaining the infusion drink material in a dry condition.

The features and advantages of the present invention will be fully understood and appreciated from the following detailed description of the preferred embodiments with reference to the accompanying drawings.

### BRIEF DESCRIPTION OF THE DRAWINGS

FIG. 1A and FIG. 1B are respectively an exploded view and an assembled view of the lid structure in a first embodiment of the present invention.

FIG. 2 is an illustrative view showing how to operate the lid structure of the present invention.

FIG. 3 is a schematic view in a second embodiment.

FIG. 4 is an illustrative view showing how to operate the lid structure in a second embodiment.

FIG. 5A and FIG. 5B are schematic view in a third embodiment.

FIG. 6A and FIG. 6B are illustrative views showing how to operate the lid structure in a third embodiment.

FIG. 7A and FIG. 7B are schematic views in a fourth embodiment.

FIG. 8A and FIG. 8B are illustrative views showing how to operate the lid structure in a fourth embodiment.

### DETAIL DESCRIPTION OF THE PREFERRED EMBODIMENTS

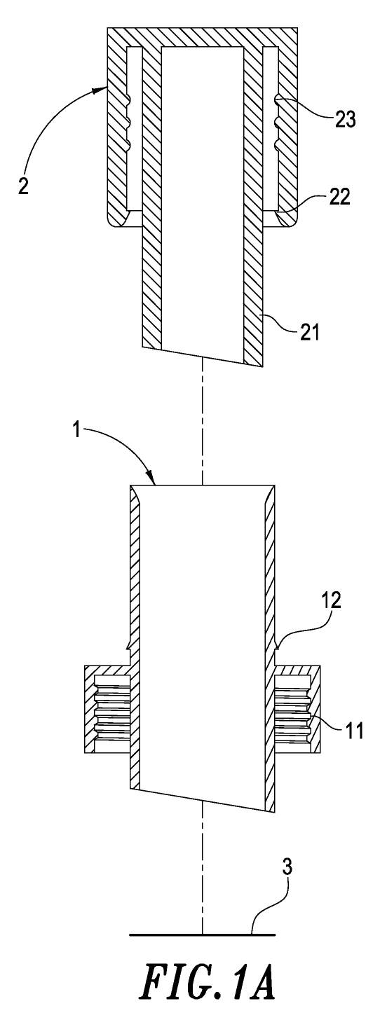

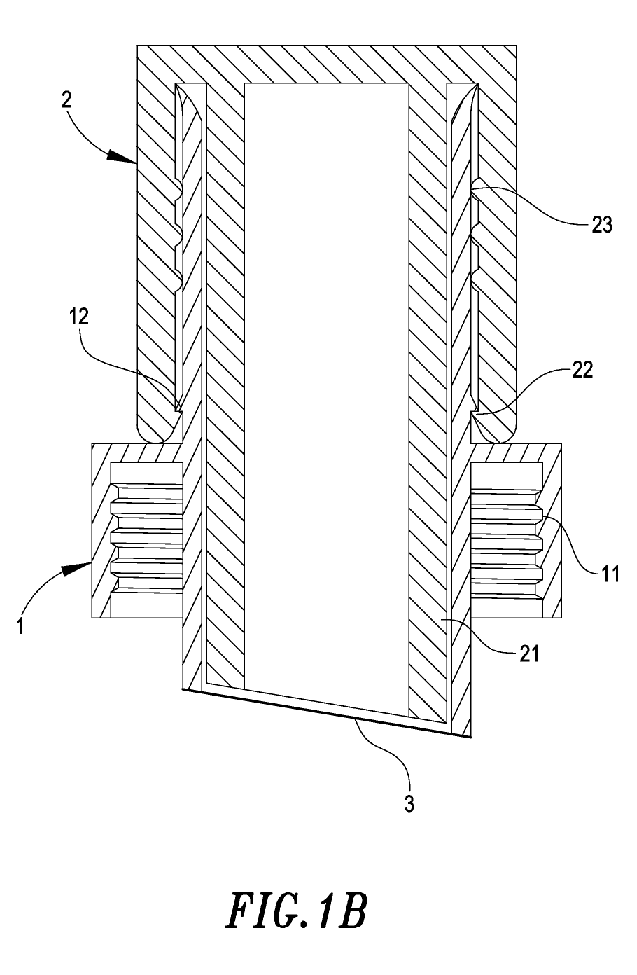

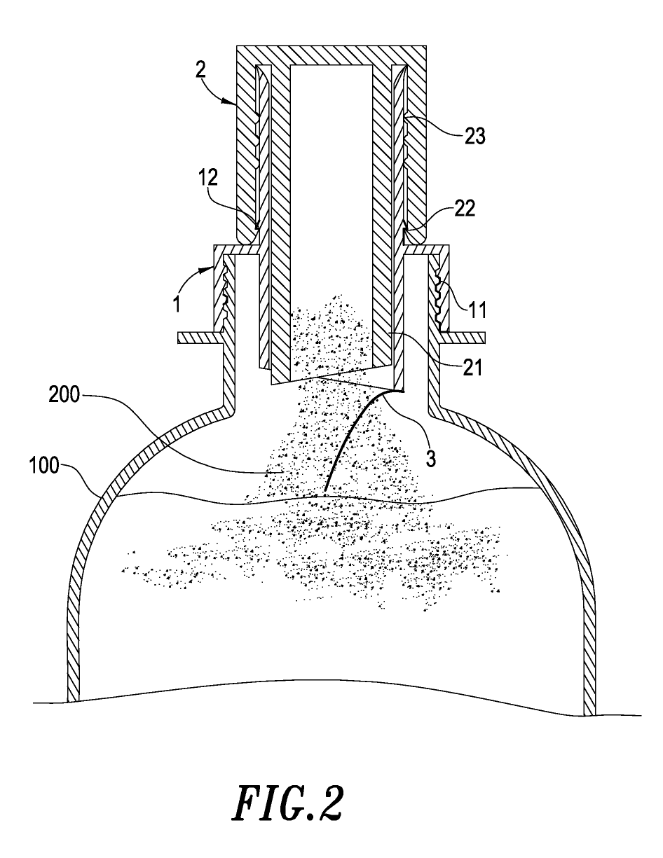

Referring to FIGS. 1A, 1B and 2 in a first embodiment of the present invention, the lid structure essentially comprises a lower lid 1, an upper lid 2 and a film 3.

The lower lid 1 is slightly flared at the upper fringe thereof, and having an engagement flange 11 formed around it with a claw 12 provided on the upper edge of the engagement flange 11 at a proper position to be hooked onto a detent 22 formed on the upper lid 2. The bottom of the lower lid 1 is formed into a tilted port. The engagement flange 11 is adaptable with the mouth of a container 100 with a universal structure purchasable on the market. The lower lid 1 is made of plastic.

The upper lid 2 has a cutting tube 21 extended downwards from the center of the upper lid 2, the bottom of the cutting tube 21 is also formed into a tilted port. On the inner side surface at the lower end of the upper lid 1 there is a detent 22, and more than one gaskets 23 are provided at a proper position around the inner side wall of the upper lid 2. The cutting tube 21 is sleeved into the lower lid 1, and the lower lid 1 and upper lid 2 are engaged with each other with the claw 12 hooked onto the detent 22. The infusion drink materials 200 such as tea leaves, the Ginseng powder or the coffee can be filled into the cutting tube 21. The upper lid 2 is made of plastic.

The film 3 is sealing the tilted port at the bottom of the lower lid 1.

The upper and lower lids 2, 1 are coupled together in one piece. Since the lower lid 1 is made of plastic, a preferable hermetical effect can be attained when the flared upper fringe of the lower lid 1 is squeezed by the inner side surface of the upper lid 2, and enhances the tightness of contact between the upper and lower lids 1, 2 (see FIG. 1B). As soon as the infusion drink material 200 has filled into the cutting tube 21 and the film 3 has sealed the tilted port at the bottom of the lower lid 1, a hermetical state is formed in the space between the two lids 1 and 2 containing the infusion drink material 200 so as to avoid moistening it. When the user intends to prepare a drink, by reason that the bottoms of the two lids 1, 2 are tilted, by turning the upper lid 2, the film 3 sealing the lower lid 1 will be cut open by the tip of the tilted port of the cutting tube 1 so as to drop the drink material 200 in the cutting 21 into the container 100 (see FIG. 2) thereby the user is able to enjoy the infused drink easily. Such a device is very convenient to the public.

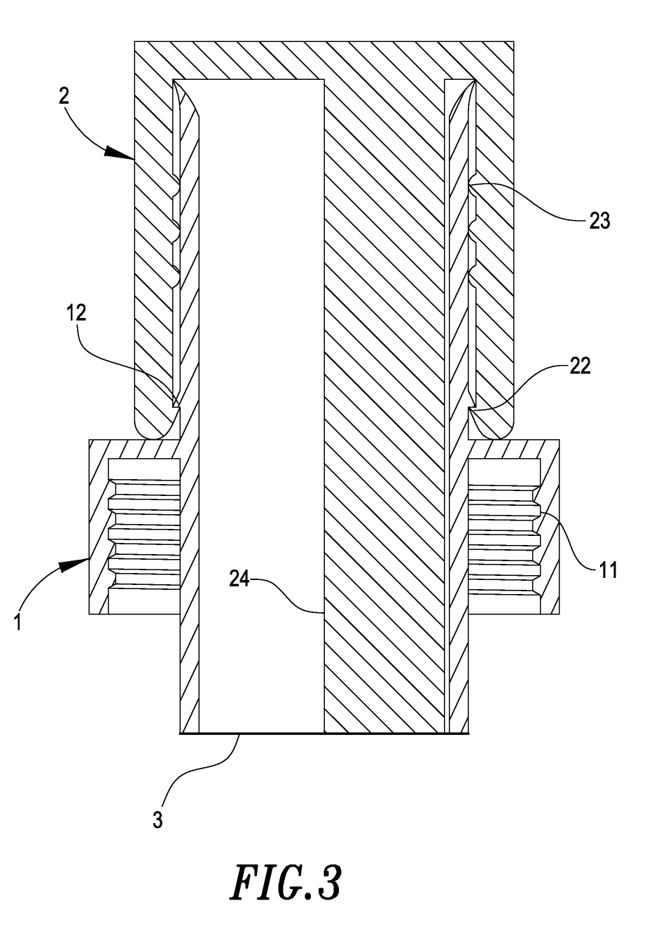

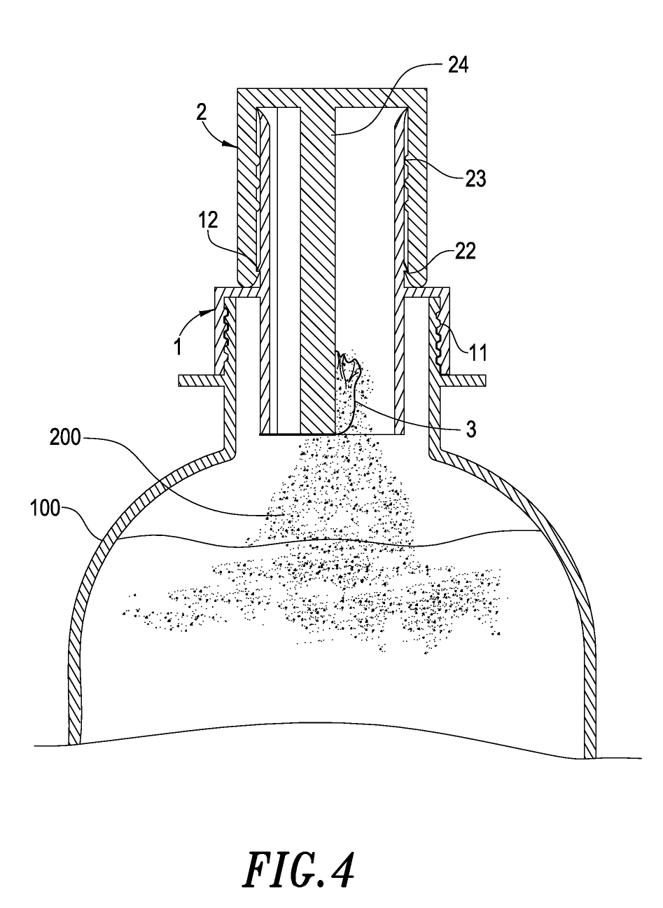

Referring to FIG. 3 and FIG. 4, in a second embodiment of the present invention, the lid structure comprises a lower lid 1, an upper lid 2 and a film 3.

The lower lid 1 is slightly flared at the upper fringe thereof, and having an engagement flange 11 formed around it with a claw 12 provided on the upper edge of the engagement flange 11 at a proper position to be hooked onto a detent 22 formed on the upper lid 2. The engagement flange 11 is adaptable with the mouth of a container 100 with a universal structure purchasable on the market. The lower lid 1 is made of plastic.

The upper lid 2 has a plate 24 extended downwards from one side thereof, and a detent 22 is formed on the inner side surface at the lower end of the upper lid 1, and more than one gaskets 23 are provided at a proper position around the inner side wall of the upper lid 2. The plate 24 of the upper lid 2 is inserted down into the lower lid 1, and the lower lid 1 and the upper 2 are engaged with each other with the claw 12 hooked onto the detent 22. After coupling together the two lids 1 and 2, an infusion drink material 200 such as the tea leaves, the Ginseng power or the coffee is filled into the upper lid 2. The upper lid 2 is made of plastic.

The film 3 seals the bottom of the lower lid 1 and is adhered to the end surface of the plate 24.

After coupling the two lids 1, 2 together, by turning the upper lid 2, the plate 24, which is adhered to the film 3 at its end surface, will break the film 3 so as to drop the infusion drink material 200 contained in the upper lid 2 into the container 100 (see FIG. 4) thereby allowing the user to enjoy the infusion drink.

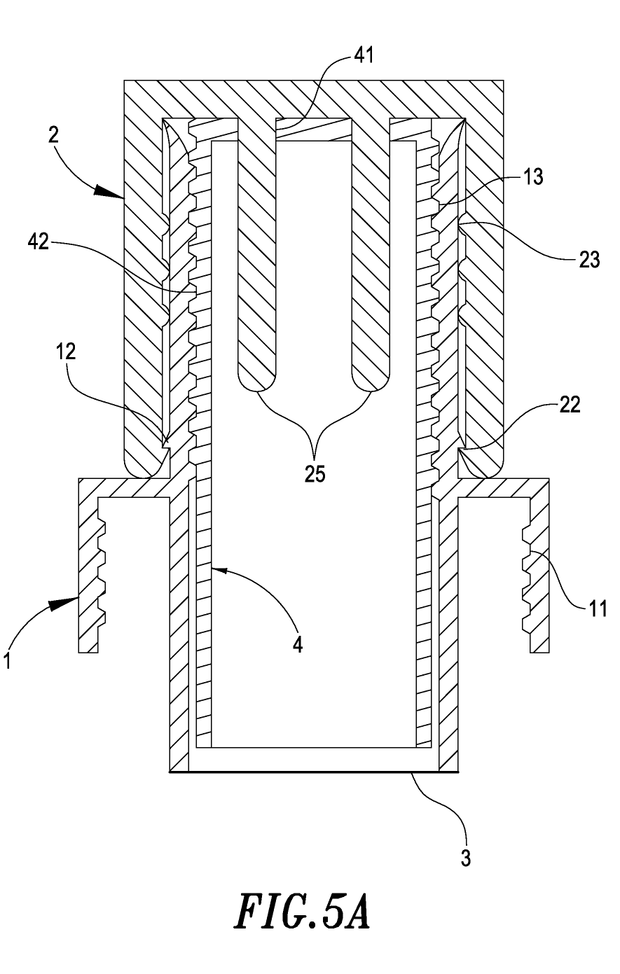

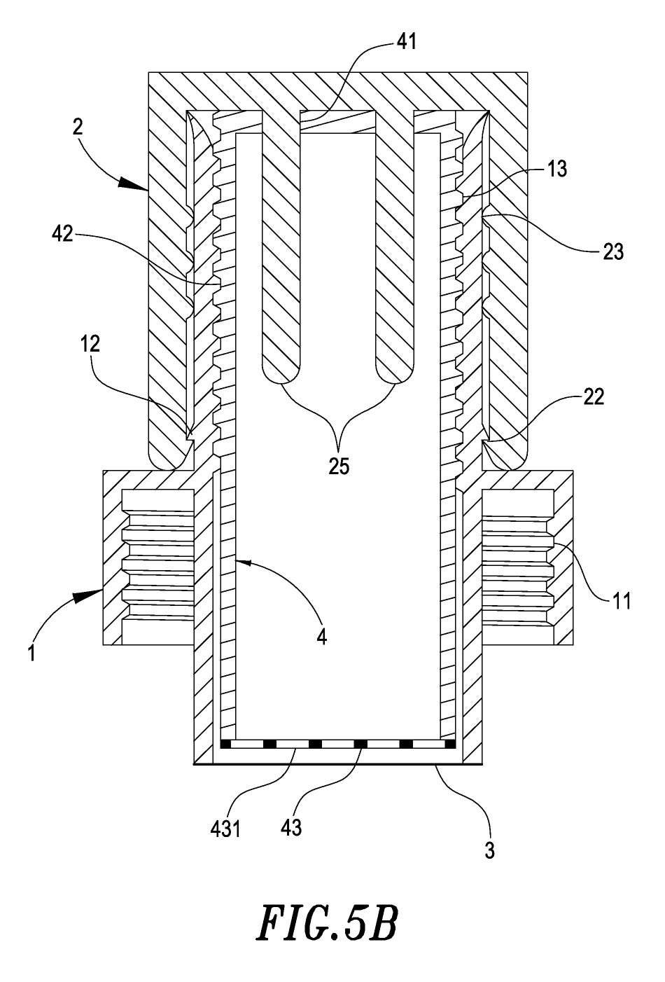

Referring to FIG. 5A and FIG. 5B, in a third embodiment of the present invention, the lid structure comprises a lower lid 1, an inner sleeve, an upper lid 2, and a film 3.

The lower lid 1 is slightly flared at the upper fringe thereof, and having an engagement flange 11 formed around it with a claw 12 provided on the upper edge of the engagement flange 11 at a proper position to be hooked onto a detent 12 formed on the upper lid 2. An interior thread 13 is formed on the inner wall surface of the lower lid 1, so as to engage with an exterior thread 42 formed on an inner sleeve 4. The engagement flange 11 is adaptable with the mouth of a container 100 with a universal structure purchasable on the market. The lower lid 1 is made of plastic.

The inner sleeve 4 is provided with more than one perforations 41 on the upper end surface, and the exterior thread 42 is formed on the outer surface of the inner sleeve 4. The inner sleeve 4 is screw engaged with the interior thread 13 of said lower lid via the exterior thread 42. An infusion drink material 200 such as the tea leaves, the Ginseng powder, or the coffee can be filled into the inner sleeve 4. There is a percolation 43 provided at the lower end of the inner sleeve 4 (see FIG. 5B), and having several percolation meshes 431 opened on it for percolating the infusion drinks such as tea and Ginseng. Similarly, the percolation meshes 431 may also be provided on the body of the inner sleeve 4 (not shown) for percolation.

There are more than one churning sticks 25 extended downward from the upper lid 2 at a proper position, and a detent 22 is formed on the inner side wall at the lower end of the upper lid 2, and more than one gaskets 23 are provided at a proper position around the inner side wall of the upper lid 2. The churning sticks of the upper lid 2 are inserted into the perforations 41 formed on the inner sleeve 4, and the two lids 1, 2 are engaged with each other with the claw 12 hooking onto the detent 22. The upper lid 2 is made of plastic.

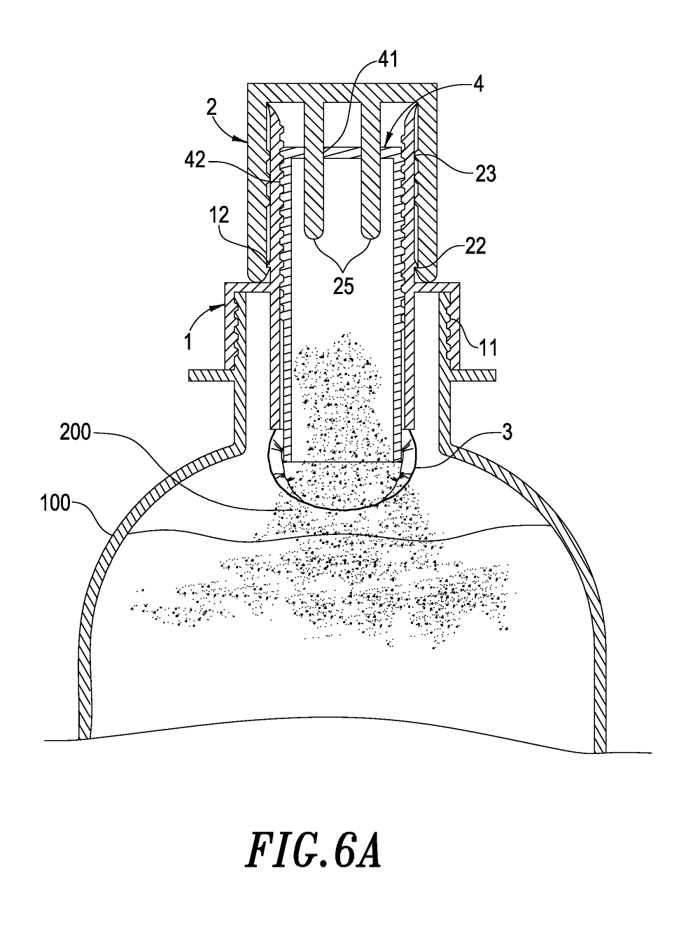

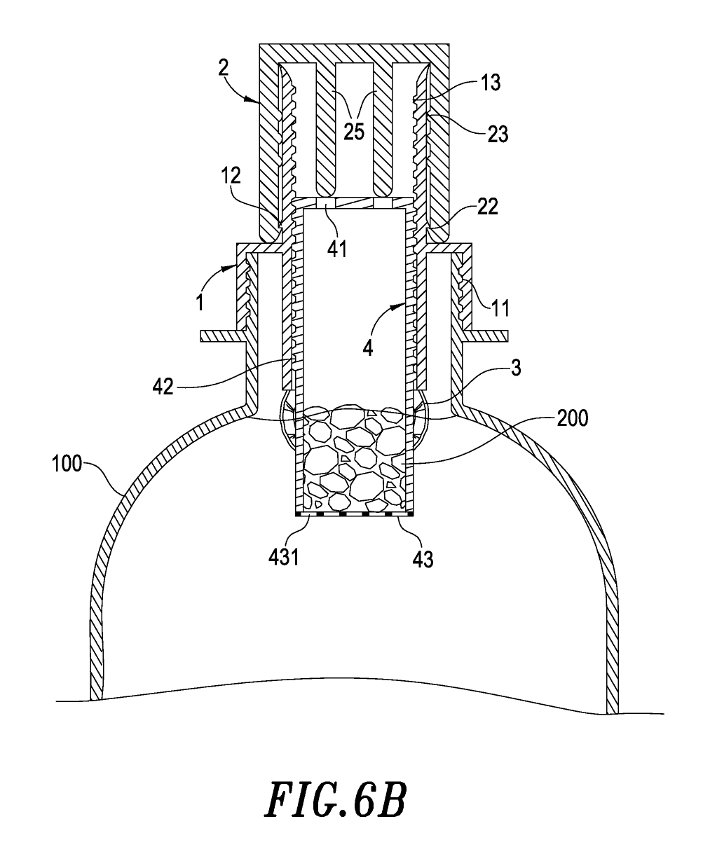

The film 3 seals the bottom of the lower lid 1, by turning the upper lid 2, the churning sticks 25 of the upper lid 2 turn to rotate the inner sleeve, when reaching a certain distance, the inner sleeve 4 will break the film 3 with its front tip so as to drop the infusion drink material 200 into the container 100 (see FIG. 6A). In case the percolation plate 43 is installed, when the user intends to percolate the drink material 200, he/she may similarly turn the upper lid 2 so as to release its churning sticks 25 out of the perforations 41 of the inner sleeve 4. At this moment the inner sleeve 4 is no more driven to rotate but continuing to descend and soaking in a water filled container 100 together with its content, the infusion drink material 200. The provision of the percolation plate 43 aids to prevent the infusion drink material 200 from accidentally diverging into the container 100 (see FIG. 6B) and never allows the drink material 200 to trespass upon the user's mouth.

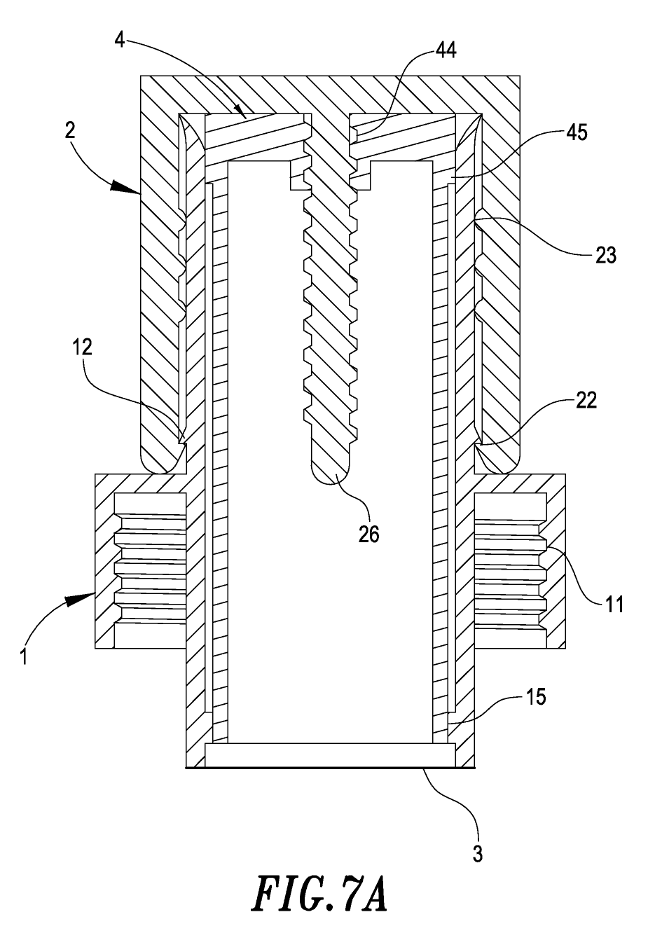

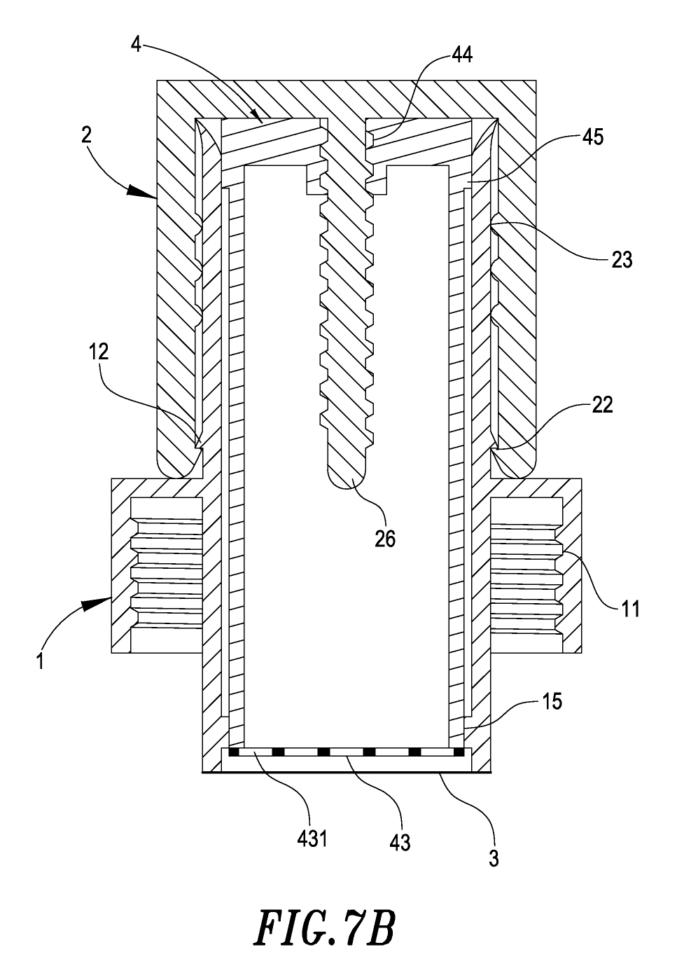

Referring to FIG. 7A and FIG. 7B, in a fourth embodiment of the present invention, the lid structure comprises a lower lid 1, an inner sleeve 4, an upper lid 2 and a film 3.

The lower lid 1 is slightly flared at the upper fringe thereof, and having an engagement flange 11 formed around it with a claw 12 provided on the upper edge of the engagement flange 11 at a proper position to be hooked onto a detent 22 formed on the upper lid 2. Along the inner side wall of the lower lid 1 there is a slide slot 14 to allow a pair of slide rails 45 provided along the inner sleeve 4 to slide up and down. A stopper 15 is formed at the lower end of the slide slot 14 to halt the moving of the inner sleeve 4 at a position. The engagement flange 11 is adaptable with the mouth of a container 100 with a universal structure purchasable on the market. The lower lid 1 is made of plastic.

The inner sleeve 4 is provided with a tapped hole 44 at its upper end surface, and the slide rail 45 is provided along each of the two sides of the inner sleeve 4. The inner sleeve 4 is settled in the slide slot 14 of the lower lid 1 along with the slide rails 45. An infusion drink materials 200 such as the tea leaves the Ginseng powder or the coffee can be filled into the inner sleeve 4. There is a percolation plate 43 provided at the lower end of the inner sleeve 4 (see FIG. 7B), and having several percolation meshes 431 opened on it for percolating the infusion drinks such as tea and Ginseng. Similarly, the percolation meshes 431 may also be provided on the body of the inner sleeve 4 (not shown) for percolation.

The upper lid 2 has a bolt 26 extended downwards from the center portion thereof, and a detent 22 is formed on the inner side surface at the lower end of the upper lid 1, and more than one gaskets 23 are provided at a proper position around the inner side wall of the upper lid 2. The bolt 26 extended down from the upper lid 2 is screw combined with the tapped hole 44 of the inner sleeve 4, and the lower lid 1 and the upper lid 2 are engaged with each other with the claw 12 hooked onto the detent 22. The upper lid 2 is made of plastic.

The film 3 seals the bottom of the lower lid 1.

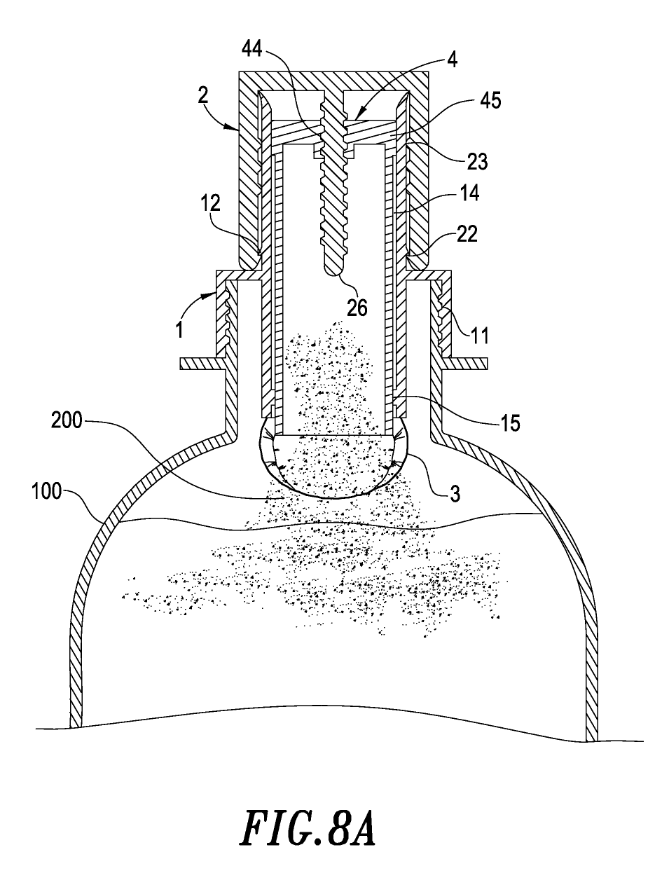

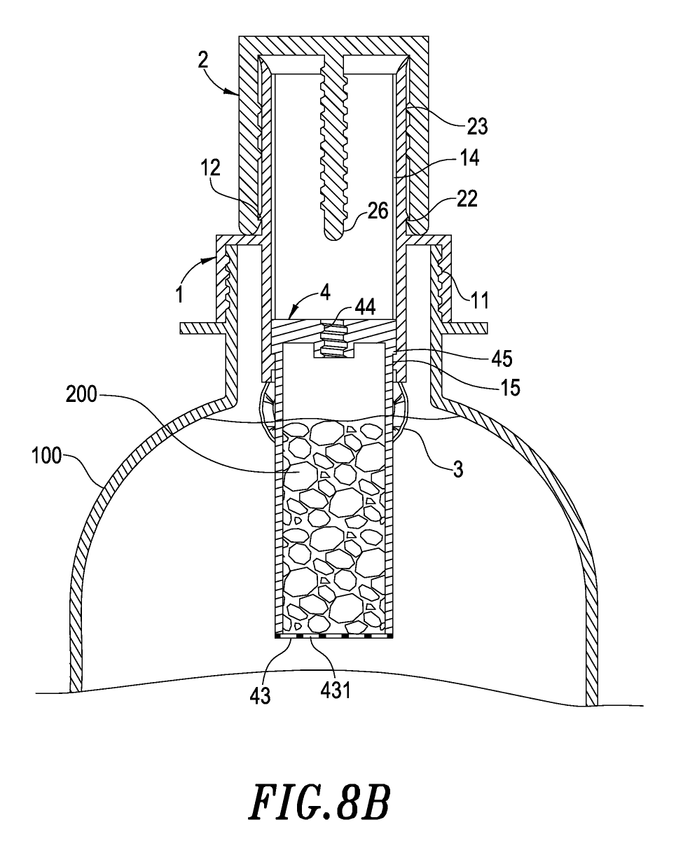

By turning the upper lid 2, the bolt 24 will drive the inner sleeve 4 downwards by screw motion to reach a certain distance so as to break the film 3 with its front tip thereby dropping the infusion drink material 200 contained in it into the container 100 (see FIG. 8A). In case the percolation plate 43 is installed, when the user intends to percolate the drink material 200, he/she may similarly turn the upper lid 2 so as to liverate its bolt 24 out of the tapped hole 44. At this moment the inner sleeve 4 will descend and detained on the slide rails 45 by the stopper 15 of the lower lid 1. The inner sleeve 4, which being filled with an infusion drink material 200, will soak in water filled in the container 100, and avoid the drink material 200 from diverging in the container 100 (see FIG. 8B) and never allows the drink material 200 to trespass upon the user's mouth.

In the first to Fourth embodiments described above, the gaskets 23 can be provided around either the inner side or the outer side of the lower lid 1 instead of around the inner side of the upper lid 2.

In short, it emerges from the description of the above embodiments that the invention has several noteworthy advantages, in particular:

1. The ingenious lid structure is adaptable to any drink container to prepare a sanitarily secure instant infusion drink for the user.

2. The lid structure is simply constructed, it can be easily handled without extra manual modification.

Many changes and modification in the above described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A lid structure for infusion drinks percolator comprising:
a lower lid having an engagement flange formed around with a claw provided on the upper edge of said engagement flange, wherein the bottom of said lower lid is formed into a first tilted port;
an upper lid having a cutting tube extended downwards from the center thereof, and the bottom of said cutting tube being formed into a second tilted port, a detent being provided on the inner side surface at the lower end of said upper lid and more than one gaskets being provided at a predetermined position around the inner side wall of said upper lid, wherein said cutting tube is sleeved into said lower lid, said lower lid and said upper lid are engaged with each other with said claw hooked onto said detent; and
a film for sealing the first tilted port at the bottom of said lower lid.

2. The lid structure of claim 1, wherein anyone infusion drink materials is allowable to fill into said cutting tube.

3. The lid structure of claim 1, wherein said lower lid is slightly flared at the upper fringe thereof so as to enhance tightness of coupling between said upper and said lower lids.

4. The lid structure of claim 1, wherein said infusion drink materials include tea leaves, tea powder, Ginseng powder, or coffee.

5. A lid structure for infusion drinks percolator comprising:
a lower lid having an engagement flange formed around with a claw provided on the upper edge of said engagement flange to be hooked onto a detent formed on an upper lid;
said upper lid having a plate extended downwards from one side thereof, and said detent being formed on the inner side surface at the lower end of said upper lid, and more than one gaskets being provided around the inner side wall of said upper lid, wherein said plate of said upper lid is inserted down into said lower lid, said lower lid and said upper lid are engaged with each other with said claw hooked onto said detent; and
a film for sealing the bottom of said lower lid and being adhered to the end surface of said plate.

6. The lid structure of claim 5, wherein an infusion drink material can be filled into said upper lid after coupling said upper and said lower lids.

7. The lid structure of claim 5, wherein said lower lid is slightly flared at the upper fringe thereof so as to enhance tightness of coupling between said upper and said lower lids.

8. The lid structure of claim 5, wherein said infusion drink materials include tea leaves, tea powder, Ginseng powder, or coffee.

9. A lid structure for infusion drinks percolator comprising:
a lower lid having an engagement flange formed around with a claw provided on the upper edge of said engagement flange to be hooked onto a detent formed on said upper lid, an interior thread being formed on the inner wall surface of said lower lid so as to engage with an exterior thread formed on an inner sleeve;
said inner sleeve being provided with more than one perforations on the upper end surface, wherein said exterior thread is formed on the outer surface of said inner sleeve, said inner sleeve is screw engaged with said interior thread of said low lid via said exterior thread;
said upper lid having more than one churning sticks, and a detent being formed on the inner side wall at the lower end of said upper lid, and more than one gaskets being provided around the inner side wall of said upper lid; wherein said churning sticks of said upper lid are inserted into said perforations formed on said inner sleeve and said two lids are engaged with each other with said claw hooking onto said detent; and
a film for sealing the bottom of said lower lid.

10. The lid structure of claim 9, wherein anyone of the infusion drink materials is allowable to fill into said inner sleeve.

11. The lid structure of claim 9, wherein a percolation plate provided with several percolation meshes is installed under said inner sleeve.

12. The lid structure of claim 9, wherein said percolation meshes are provided on said inner sleeve.

13. The lid structure of claim 9, wherein said lower lid is slightly flared at the upper fringe thereof so as to enhance tightness of coupling between said upper and said lower lids.

14. The lid structure of claim 9, wherein said infusion drink materials include tea leaves, tea powder, Ginseng powder, or coffee.

15. A lid structure for infusion drinks percolator comprising:
a lower lid having an engagement flange formed around with a claw provide on the upper edge of said engagement flange, a slide slot being formed along the inner side wall of said lower lid so as to allow a pair of slide rails provided along an inner sleeve to slide up and down, and a stopper being formed at the lower end of said slide slot to halt the moving of said inner sleeve at a position;
said inner sleeve being provided with a tapped hole at the upper end surface thereof, wherein said slide rail is provided along each of the two sides of said inner sleeve, and said inner sleeve is settled in said slide slot of said lower lid along with said slide rails;
an upper lid having a bolt extended downwards from the center portion thereof, and a detent being formed on the inner side surface at the lower end of said upper lid, more than one gaskets being provided around the inner wall surface of said upper lid wherein said bolt extended down from said upper lid is screw combined with said tapped hole of said inner sleeve, and said lower lid and said upper lid are engaged with each other with said claw hooked onto said detent; and
a film for sealing the bottom of said lower lid.

16. The lid structure of claim 9, wherein anyone of the infusion drink materials is allowable to fill into said inner sleeve.

17. The lid structure of claim 9, wherein a percolation plate provided with several percolation meshes is installed under said inner sleeve.

18. The lid structure of claim 9, wherein said percolation meshes are provided on said inner sleeve.

19. The lid structure of claim 4, wherein said lower lid is slightly flared at the upper fringe thereof so as to enhance tightness of coupling between said upper and said lower lids.

20. The lid structure of claim 4, wherein said infusion drink materials include tea leaves, tea powder, Ginseng powder, or coffee.
